(19) United States
(12) Patent Application Publication
(10) Pub. No.: US 2010/0116920 A1
(43) Pub. Date: May 13, 2010

(54) Bait Reel For Fishing

(76) Inventor: Sung Hyun LEE, Yongin-si (KR)

Correspondence Address: PARK LAW FIRM, 3255 WILSHIRE BLVD, SUITE 1110, LOS ANGELES, CA, 90010, US

(21) Appl. No.: 12/332,698

(22) Filed: Dec. 11, 2008

(30) Foreign Application Priority Data
Nov. 10, 2008 (KR) 10-2008-0111283

(51) Int. Cl. A01K 89/033

(52) U.S. Cl. 242/291

(57) ABSTRACT

The invention relates to a bait reel for fishing including: a handle; a spool, the spool being adapted to wind a fishing line and to unwind the fishing line by a reverse rotation; and a brake device which includes: a one-way clutch bearing coupled to a rotary shaft of the spool and constrained in the rotation upon the reverse rotation of the spool; a brake disc on which the one-way clutch bearing is fixed, the brake disc is rotated integrally together with the one-way clutch bearing upon the reverse rotation of the spool; and a manipulating member having a brake shoe fixedly mounted at one end portion and hinge-coupled to a casing to which the spool is fixed such that rotation is allowed by an angle to permit the brake shoe to come into close contact with the brake disc, thereby allowing a braking force to be adjustable.

### BACKGROUND OF THE INvENTION

1. Field of the Invention

The present invention relates to a bait reel for fishing, and more particularly, to a bait reel for fishing that restricts a reverse rotation of a spool unwinding a fishing line by means of a brake device applying a braking force adjustable by a user's manipulation, to such an extent that when the fishing line is pulled, it is not cut by the fish caught by the fishing line, thereby winding the fishing line while preventing the fishing line from being continuously unwound.

2. Background of the Related Art

Generally, a bait reel is used for fly fishing or lure fishing, which has a spool freely rotated forwardly and reversely such that a fishing line is smoothly wound on and unwound from the spool.

As an example of a conventional prior art bait reel, Korean Patent Laid-Open Publication No. 2003-0033105 discloses a double-bearing type bait reel for a bait casting mounted on a fishing rod, including: a basic unit having a spool for winding and unwinding a fishing line by forward and reverse rotations, a spool-driving mechanism for rotating the spool, and a mounting frame for connecting the spool and the spool-driving mechanism in such a manner as to allow them to be operated cooperatively with each other; and an outer shell part mounted on the mounting frame of the basic unit, wherein the basic unit further includes a brake mechanism for restricting the rotation of the spool and a level winding mechanism for arranging and winding the fishing line on the spool, and wherein the spool-driving mechanism includes a clutch mechanism adapted to allow the spool to be freely rotated in forward and reverse directions while the bait reel is not being operated and a drag mechanism adapted to restrict the reverse rotation of the spool if a tensile force is applied to the fishing line at the state where the clutch mechanism is operated.

In the general configuration of the bait reel, a rotary shaft of the spool is gear-coupled to the driving shaft of a handle, and as the handle is rotated, the spool is rotated, such that the fishing line is wound by the forward rotation of the spool and is unwound by the reverse rotation of the spool.

According to the above-mentioned conventional bait reel, the drag mechanism, which serves to prevent the forward rotation of the spool, generates a braking force therefrom when the fishing line is pulled and unwound by the fish caught by the fishing line, such that the spool is not rotated reversely. In this case, if a force pulled by the fish caught by the fishing line is more than a predetermined level, an excessive tensile force is caused on the fishing line by the braking force against the reverse rotation of the spool caused by the drag mechanism and by the force pulled by the fish caught by the fishing line. At this time, it is difficult to momentarily manipulate the drag mechanism against the resistance of the fish caught by the fishing line, such that the fishing line may be overwhelmed by the tensile force generated thereon, thereby being finally cut.

That is, the drag mechanism mounted on the conventional bait reel applies a predetermined braking force to the spool, irrespective of the force pulled by the fish caught by the fishing line. Thus, if the force pulled by the fish caught by the fishing line is larger than the predetermined braking force, the spool is rotated reversely to unwind the fishing line therefrom. However, the drag mechanism of the conventional bait reel fails to adjust the braking force easily, freely and smoothly by a user's manipulation, such that if the fish caught by the fishing line pulls the fishing line with the force that is larger than the braking force against the reverse rotation of the spool, the fishing line is frequently broken, resulting in a reduction in the number of fish caught.

### SUMMARY OF THE INVENTION

Accordingly, the present invention has been made in view of the above-mentioned problems occurring in the prior art, and it is an object of the present invention to provide a bait reel for fishing that restricts a reverse rotation of a spool unwinding a fishing line by means of a brake device applying a braking force adjustable by a user's manipulation, to such an extent that when the fishing line is pulled, it is not cut by the fish caught by the fishing line, thereby winding the fishing line while preventing the fishing line from being continuously unwound.

It is another object of the present invention to provide a bait reel for fishing that has a one-way clutch bearing adapted not to be reversely rotated and fitted along a rotary shaft of a spool and a brake disc on which the one-way clutch bearing is fixed adapted to come into close contact with a brake shoe rotated at a predetermined angle by a user's manipulation so as to restrict a reverse rotation of the spool unwinding a fishing line, to such an extent that when the fishing line is pulled, it is not cut by the fish caught by the fishing line, thereby winding the fishing line while preventing the fishing line from being continuously unwound.

To accomplish the above objects, according to the present invention, there is provided a bait reel for fishing including: a handle; a spool connected to the handle, the spool being adapted to wind a fishing line by the forward rotation thereof and to unwind the fishing line by the reverse rotation thereof; and a brake device which includes: a one-way clutch bearing coupled to a rotary shaft of the spool and constrained in the rotation thereof upon the reverse rotation of the spool; a brake disc on which the one-way clutch bearing is fixed, the brake disc being adapted to be rotated integrally with the one-way clutch bearing upon the reverse rotation of the spool; and a manipulating member having a brake shoe fixedly mounted at one end portion thereof and hinge-coupled to a casing to which the spool is fixed in such a manner as to be rotated by a predetermined angle by a user's manipulation to permit the brake shoe to come into close contact with the brake disc, thereby allowing a predetermined braking force for the brake disc to be adjustable by the user's manipulation, wherein the brake shoe of the manipulating member comes into close contact with the brake disc rotated integrally with the spool in accordance with the constraint in the rotation of the one-way clutch bearing coupled to the spool, such that the reverse rotation of the spool is restricted manually by the user's manipulation, without any restriction in the forward rotation of the spool, thereby allowing the fishing line to be wound on the spool.

According to the present invention, the brake disc includes: a disc-shaped brake drum having a fixing hole formed at the center thereof so as to allow the one-way clutch bearing to be pressingly fit thereto; and a brake ring fittingly mounted detachably on the outer periphery of the brake drum in such a manner as to be exchangeable, the brake ring being adapted to abut against the brake shoe of the manipulating member.

According to the present invention, the manipulating member includes: a brake lever having fixing pins disposed at both ends thereof in such a manner as to be hinge-coupled to the casing to which the spool is fixed; the brake shoe eccentrically fixed to a fixing pin at one side of the brake lever so as to come into close contact with the brake disc in accordance with the rotation of the brake lever; and an elastic spring mounted between a fixing pin at the other side of the brake lever and the casing so as to apply an elastic force to the brake lever.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a cross-sectional view showing the entire configuration of a bait reel for fishing according to a preferred embodiment of the present invention;

FIG. 2 is a cross-sectional view showing the principal configuration of the bait reel for fishing according to the preferred embodiment of the present invention;

FIG. 3 is an exploded perspective view showing the principal parts of the bait reel for fishing according to the preferred embodiment of the present invention; and

FIG. 4 is a view showing the operation of the brake device of the bait reel for fishing according to the preferred embodiment of the present invention.

### DETAILED DESCRIPTION OF THE PREFERRED EMBODIMENT

A bait reel 1 for fishing according to the present invention is used for fly fishing or lure fishing, and the bait reel 1 includes a handle 2 and a spool 3 connected to the handle 2 in such a manner as to be freely rotated forwardly and reversely, thereby winding a fishing line by the forward rotation thereof and unwinding the fishing line by the reverse rotation thereof. According to the present invention, the bait reel 1 for fishing has a one-way clutch bearing 20 adapted not to be reversely rotated and adapted to be fitted along a rotary shaft 5 of the spool 3 and a brake disc 40 on which the one-way clutch bearing 20 is fixed, the brake disc being adapted to abut against a brake shoe 64 rotated at a predetermined angle by a user's manipulation, thereby restricting a reverse rotation of the spool 3 unwinding the fishing line to adjust the braking force by the user's manipulation, to such an extent that when the fishing line is pulled, it is not cut by the fish caught by the fishing line, such that the fishing line is wound on the spool 3, while preventing the fishing line from being continuously unwound from the spool 3.

Hereinafter, an explanation on a bait reel for fishing according to a preferred embodiment of the present invention will be given with reference to the attached drawings. In the description of the present invention and the drawings thereof, on the other hand, detailed descriptions and illustration on the construction and operation of the general bait reel for fishing that can be apparently appreciated by those skilled in the art will be simplified or omitted. More particularly, the detailed technical construction and operation of the elements not related directly to the technical characteristics of the present invention will be not described and illustrated herein, and only the technical configuration related to the present invention will be simply illustrated and explained.

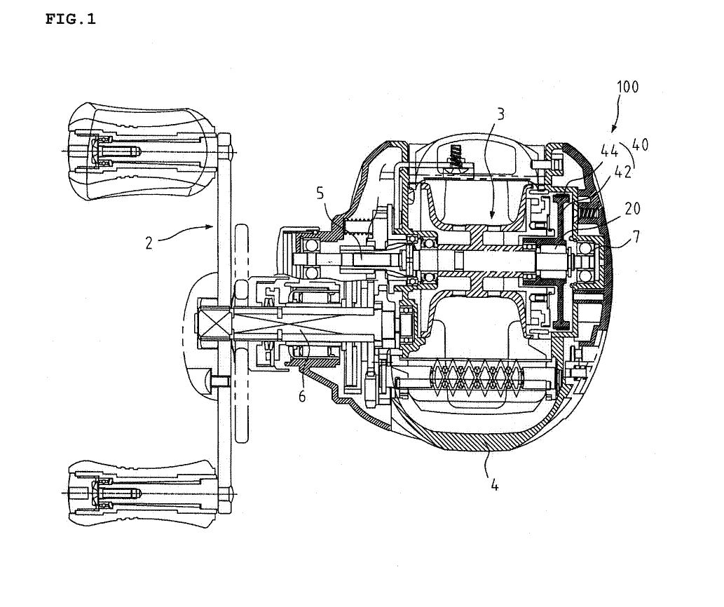

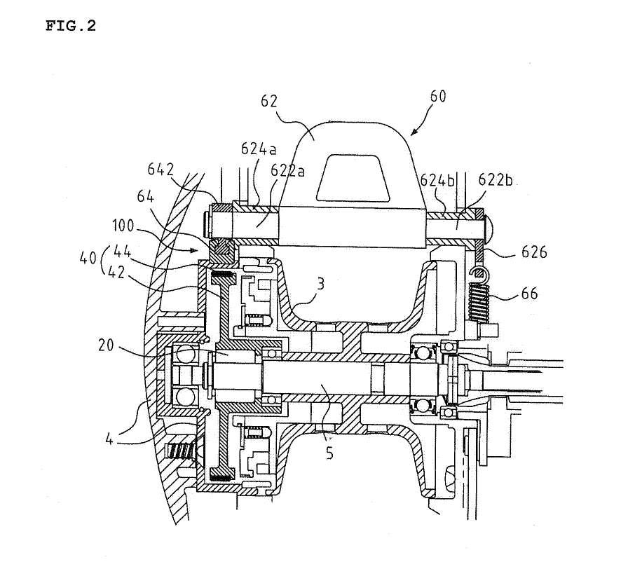

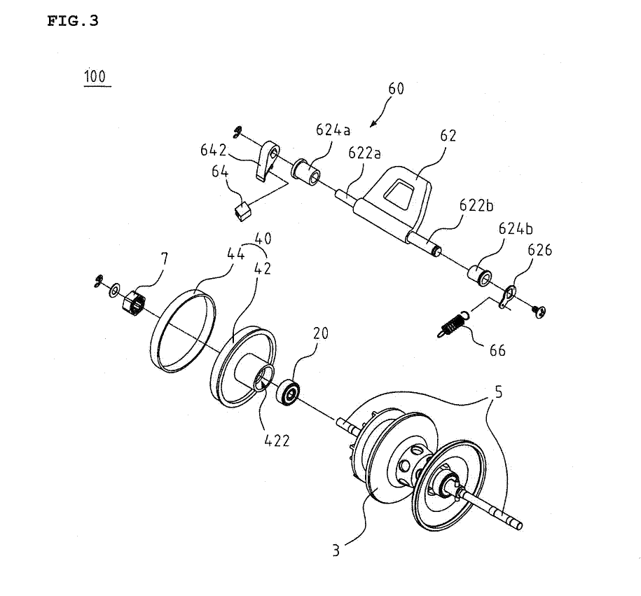

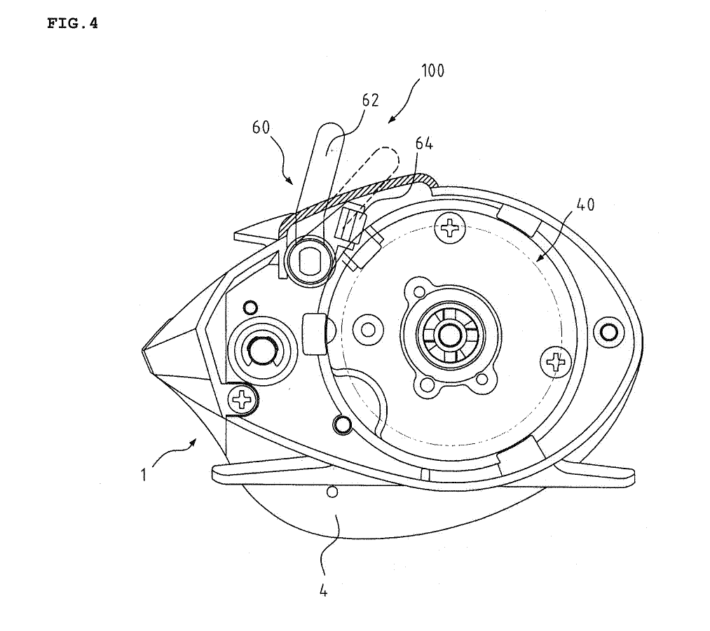

FIG. 1 is a cross-sectional view showing the entire configuration of a bait reel for fishing according to a preferred embodiment of the present invention, FIG. 2 is a cross-sectional view showing the principal configuration of the bait reel for fishing according to the preferred embodiment of the present invention, FIG. 3 is an exploded perspective view showing the principal parts of the bait reel for fishing according to the preferred embodiment of the present invention, and FIG. 4 is a view showing the operation of the brake device of the bait reel for fishing according to the preferred embodiment of the present invention.

The bait reel 1 for fishing according to the present invention includes the spool 3 has a rotary shaft 5 connected to a handle shaft 6 of the handle 2 so as to wind the fishing line by the forward rotation thereof and to unwind the fishing line by the reverse rotation thereof, in accordance with the operation of the handle 2, and a brake device 100. According to the preferred embodiment of the present invention, the brake device 100 includes: the one-way clutch bearing 20, the brake disc 40, and a manipulating member 60.

The one-way clutch bearing 20 is a bearing that is rotated in only one direction, which is coupled to the rotary shaft 5 of the spool 3 such that if the spool 3 is forwardly rotated, it is rotated and if reversely rotated, it is not rotated. The one-way clutch bearing 20 is insertedly fixed to the end portion of the outer periphery of the rotary shaft 5, and according to the present invention, as shown in FIGS. 1 and 2, the spool 3 has a ball bearing 7 fixedly fitted to the end of the rotary shaft 5 along which the one-way clutch bearing 20 is fitted, thereby permitting the rotary shaft 5 to be stably rotated.

The brake disc 40 has the one-way clutch bearing 20 fixed thereto, such that it can be rotated integrally with the one-way clutch bearing 20 upon the reverse rotation of the spool 3. Therefore, the brake disc 40 is fixed to the rotary shaft 5 of the spool 3 by means of the one-way clutch bearing 20 and is placed at the inside of a casing 4 with no constraint in the rotation thereof. If the spool 3 is forwardly rotated, thus, the brake disc 40 is maintained at a halting state, and if the spool 3 is reversely rotated, the rotary shaft 5 of the spool 3, the one-way clutch bearing 20 and the brake disc 40 are reversely rotated integrally with each other.

According to the present invention, as shown in FIGS. 1 to 3, the brake disc 40 includes a brake drum 42 and a brake ring 44.

As shown in FIG. 3, the brake drum 42 is of a disc-shaped body having a fixing hole 422 formed at the center thereof in such a manner as to pressingly fit the one-way clutch bearing 20 to the fixing hole 422, thereby being formed integrally with the one-way clutch bearing 20. Of course, the one-way clutch bearing 20 may be fixed to the brake drum 42 in a variety of manners instead of the press fitting.

The brake ring 44 is fittingly mounted around the outer periphery of the brake drum 42 in such a manner as to abut against the brake shoe 64 of the manipulating member 60. Since the brake ring 44 is a component that is worn by frequently abutting against the brake shoe 64, it is fittingly mounted detachably around the outer periphery of the brake drum 42 in such a manner as to be exchangeable.

The manipulating member 60, which is operated manually by the user's manipulation, and includes the brake shoe 64 fixedly mounted at one end portion thereof. The manipulating member 60 is hinge-coupled to the casing 4 in which the spool 3 is fixed, and as shown in FIG. 4, it is rotated by a predetermined angle by the user's manipulation to permit the brake shoe 64 to come into close contact with the brake disc 40. Since the rotating angle of the manipulating member 60 is adjusted manually by the user's manipulation to control a degree of contact (that is, a pressurizing force of the brake shoe 64 against the brake disc 40) between the brake shoe 64 and the brake disc 40, the braking force for the brake disc 40 can be easily and smoothly adjusted by the user's manipulation.

When the fishing line is unwound to rotate the spool 3 reversely such that the rotary shaft 5 of the spool 3, the one-way clutch bearing 20 and the brake disc 40 are reversely rotated integrally with each other, the manipulating member 60 brakes the reverse rotation of the brake disc 40. In this case, the manipulating member 60 serves to prevent the fishing line from being continuously unwound from the spool 3 when the fishing line is pulled by the fish caught by the fishing line, and further, it serves to adjust the braking force for the brake disc 40 by the user's manipulation to allow the fishing line to be temporarily unwound when the fishing line is pulled strongly by the fishing caught thereby, thereby preventing the fishing line from being unexpectedly cut.

On the other hand, in the brake device 100 of the bait reel 1 for fishing according to the present invention the brake shoe 64 of the manipulating member 60 comes into close contact with the brake disc 40 by means of the one-way clutch bearing 20, such that the spool 3 can be rotated forwardly even at the state where the braking force is applied to the brake disc 40. Therefore, the fishing line can be repeatedly wound and unwound in a rapid manner in accordance with the operating state of the fish caught by the fishing line during the fishing, thereby easily carrying out the fish-catching operation.

According to the present invention, the manipulating member 60 includes the brake lever 62, the brake shoe 64 and an elastic spring 66.

The brake lever 62 is a component that is held and rotated directly by the user's hand and has fixing pins 622a and 622b having a predetermined length disposed at both ends thereof in such a manner as to be hinge-coupled to the casing 4 in which the spool 3 is fixed.

In this case, the fixing pins 622a and 622b are rotatably fixed to a body frame of the bait reel 1 in such a manner as to be fittingly coupled to bushes 624a and 624b disposed at both sides thereof.

The brake shoe 64 is eccentrically fixed to one side fixing pin 622a of the brake lever 62 at a position corresponding to the outer peripheral surface of the brake ring 44 of the brake disc 40 in such a manner as to come into close contact with the brake ring 44 in accordance with the rotation of the brake lever 62. The brake shoe 64 is spaced apart from the brake ring 44 when the brake lever 62 is in a neutral state (that is, in the state where the brake lever is not moved, without any manipulation by the user).

According to the present invention, in this case, the brake shoe 64 is manufactured to a small size conforming to the width of the outer periphery of the brake ring 44. Further, the brake shoe 64 is detachably coupled to a brake shoe holder 642 fixed to a fixing pin 622a at one side of the brake lever 62. The aim of this is to smoothly and easily exchange the brake shoe 64 because the brake shoe 64 is a component that is abraded while frequently coming into close contact with the brake ring 44.

The elastic spring 66 is mounted between the casing 4 and the other side fixing pin 622b positioned at the opposite side to the fixing pin 622a at one side of the brake lever 62 to which the brake shoe 64 is fixed.

In this case, the elastic spring 66 according to the preferred embodiment of the present invention is fixed at one end thereof to a spring-fixing plate 626 fixed to the other side fixing pin 622b of the brake lever 62 and is fixed at the other end thereof to the body frame of the bait reel 1 so as to apply an elastic force to the brake lever 62, thereby allowing the brake lever 62 to be in a neutral state (that is, in the state where the brake shoe 64, is positioned spaced apart from the brake ring 44) when no external force is applied.

When the brake lever 62 is rotated by the user's manipulation, the elastic spring 66 applies a restoring force toward an opposite direction to the rotated direction of the brake lever 62, such that the balancing between the force applied to the brake lever 62 by the user's manipulation and the restoring force of the elastic spring 66 can be achieved to allow the brake lever 62 to be stably and minutely manipulated and to prevent the brake lever 62 from being rapidly rotated when the force generated by the user's manipulation and applied to the brake lever 62 is more than a predetermined level.

If no force is applied further to the brake lever 62 by the user's manipulation, the brake lever 62 is automatically returned to its neutral state.

Under the above-mentioned configuration, according to the bait reel 1 for fishing according to the present invention, the brake disc 40 is rotated integrally with the spool 3 by the constraint of the rotation of the one-way clutch bearing 20 coupled to the spool 3 rotated reversely when the fishing line is unwound, and the brake shoe 64 of the manipulating member 60 comes into close contact with the brake disc 40 rotated integrally with the spool 3, thereby braking the reverse rotation of the spool 3.

In this case, the brake shoe 64 of the manipulating member 60 is manipulated manually by the user in accordance with the rotation of the brake lever 62, thereby adjusting the degree of contact between the brake shoe 64 and the brake disc 40 to allow the braking force to be appropriately adjusted, such that even though the fishing line is strongly pulled by the fish caught by the fishing line, it is not cut at all and is repeatedly wound and unwound in a rapid manner in accordance with the operating state of the fish caught by the fishing line.

As described above, the bait reel for fishing according to the present invention can restrict the reverse rotation of the spool unwinding the fishing line by means of the brake device applying a braking force adjustable by the user's manipulation, such that even though the fishing line is strongly pulled by the fish caught by the fishing line, it is not broken at all so as to prevent the number of fish caught from being decreased.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A bait reel for fishing comprising:
a handle;
a spool connected to the handle, the spool being adapted to wind a fishing line by the forward rotation thereof and to unwind the fishing line by the reverse rotation thereof; and
a brake device which includes:
a one-way clutch bearing coupled to a rotary shaft of the spool and constrained in the rotation thereof upon the reverse rotation of the spool;
a brake disc comprising a disc-shaped brake drum having a fixing hole formed at the center thereof so as to allow the one-way clutch bearing to be pressingly fit thereto and a brake ring fittingly mounted detachably on the outer periphery of the brake drum in such a manner as to be exchangeable, the brake ring being adapted to abut against the brake shoe of the manipulating member, wherein the one-way clutch bearing is fixed on the brake disk, the brake disc being adapted to be rotated integrally with the one-way clutch bearing upon the reverse rotation of the spool; and
a manipulating member comprising a brake lever having fixing pins disposed at both ends thereof in such a manner as to be hinge-coupled to the casing to which the spool is fixed, the brake shoe eccentrically fixed to one of the fixing pins at one side of the brake lever so as to come into close contact with the brake disc in accordance with the rotation of the brake lever, and an elastic spring mounted between one of the fixing pins at the other side of the brake lever and the casing so as to apply an elastic force to the brake lever, wherein the manipulating member has a brake shoe fixedly mounted at one end portion thereof and hinge-coupled to a casing to which the spool is fixed in such a manner as to be rotated by a predetermined angle by a user's manipulation to permit the brake shoe to come into close contact with the brake disc, thereby allowing a predetermined braking force for the brake disc to be adjustable by the user's manipulation,
whereby the brake shoe of the manipulating member comes into close contact with the brake disc rotated integrally with the spool in accordance with the constraint or prevention in the rotation of the one-way clutch bearing coupled to the spool, such that the reverse rotation of the spool is restricted or prevented manually by the user's manipulation, without any restriction in the forward rotation of the spool, thereby allowing the fishing line to be wound on the spool.

2. (canceled)

3. (canceled)

4. (canceled)
